(19) United States
(12) Patent Application Publication
(10) Pub. No.: US 2002/0037157 A1
(43) Pub. Date: Mar. 28, 2002

(54) Image recording apparatus and image recording method

(76) Inventors: Fusahiko Hasegawa, Kanagawa-ken (JP); Hajime Nose, Kanagawa (JP); Kazuhiko Taniyama, Kanagawa-ken (JP)

Correspondence Address: BROWN RUDNICK FREED AND GESMER P C, BOX IP, 18TH FLOOR ONE FINANCIAL CENTER, BOSTON, MA, 02111, US

(21) Appl. No.: 09/900,794

(22) Filed: Jul. 6, 2001

(30) Foreign Application Priority Data
Jul. 31, 2000 (JP) 2000-232026

(51) Int. Cl. H04N 5/92

(52) U.S. Cl. 386/69; 386/95

(57) ABSTRACT

A recording apparatus for storing a motion picture having image data, comprises: a recording unit including an image storage area portion and an index area portion; an image writing unit which sequentially writes the image data of the motion picture into the image storage area portion of the recording unit; an address writing unit which writes an address to address a first image data of the motion picture into the index area portion of the recording unit as a start address of the motion picture; and a memory in which an address to address a last image data which has been stored into the image storage area portion of the recording unit is stored.

This patent application claims priority from a Japanese patent application No. 2000-232026 filed on Jul. 31, 2000, the contents of which are incorporated herein by reference.

### BACKGROUND OF THE INVENTION

1. Field of the Invention

The present invention relates to a recording apparatus and a recording method, for recording image data of a motion picture. In particular, the present invention relates to a recording apparatus and recording method in which a motion picture is stored with a start address for addressing the first image data of the motion picture and an end address for addressing the last image data of the motion picture.

2. Description of the Related Art

There are recording apparatuses which store digital moving image data supplied from image capturing equipment such as a digital video camera through an IEEE1394 port without any motion picture compressing process such as MPEG (Moving Picture Expert Group) compression. Some of these recording apparatuses have a digital video tape serving as a recording medium. Others install a hard disk which has a large capacity of several giga bytes within the body.

FIG. 1 shows an example of a data format for a recording unit which comprises a recording medium capable of random access in a recording apparatus. In this example, the recording unit has an image storage area portion which stores image data of a motion picture, and an index area portion which stores addresses of the prescribed image data. These addresses, which are a start address for addressing a storage position of the first image data of the motion picture and an end address for addressing a storage position of the last image data of the motion picture, are stored in the index storing portion. When the image data thus stored in the recording unit is reproduced by reproducing equipment, the reproducing equipment establishes the first and last image data in the motion picture, based on the start and end addresses stored in the index area portion. Then, the reproducing equipment reproduces the image data of the motion picture recorded in the recording apparatus.

The start address is written into the index area portion, when a user operates a recording start switch of the image capturing equipment. The end address is written into the index are a portion, when the user operates a recording stop switch of the image capturing equipment. The index are a portion is thus formed. When recording is completed the motion picture is finished and the reproducing equipment can reproduce the image data of the motion picture according to the address data written in the index area portion.

However, there is a problem that the end address is not written in an event that the electric power of the recording apparatus runs out during recording. A similar problem occurs such that the end address is not written if the electric power is shut down by disconnecting a cable which electrically connects between the image capturing equipment and the recording apparatus. Under these circumstances, even though the image data of the motion picture is actually recorded in the recording apparatus, it is hard to reproduce the image data since the reproducing equipment is not able to recognize the last image data in the motion picture. Assuming that it is possible to continuously overwrite a renewal address of the image data recently stored as the end address into the index area portion during recording, the above-mentioned problem might be solved. Practically, it is difficult to keep on renewing the end addresses because importing image data takes more time.

### SUMMARY OF THE INVENTION

Therefore, it is an object of the present invention to provide an image recording apparatus and method, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, there is provided a recording apparatus for storing a motion picture having image data, said recording apparatus comprising: a recording unit including an image storage area portion and an index area portion; an image writing unit which sequentially writes the image data of the motion picture into the image storage area portion of the recording unit; an address writing unit which writes an address for addressing a first image data of the motion picture into the index area portion of the recording unit as a start address of the motion picture; and a memory in which an address for addressing a last image data which has been stored into the image storage area portion of the recording unit is stored.

In the recording apparatus described above, each time the image writing unit has written the image data into the image storage area portion, the address writing unit may rewrite an address of the newly stored image data over the address presently stored in the memory.

In the recording apparatus described above, the address writing unit may rewrite the address each time the image data of one frame has been stored in the image storage area portion.

In the recording apparatus described above, flag data which indicates whether an end address for addressing the last image data of the motion picture is written or not into the index area portion may be stored in the memory.

The recording apparatus described above may further comprises: an index confirming unit which checks, based on the flag data, whether the end address for addressing the last image data of the motion picture is written or not into the index area portion.

In the recording apparatus described above, upon turning on the recording unit after the recording unit is turned off once, the index confirming unit may check whether the end address is written or not into the index area portion.

In the recording apparatus described above, if the index confirming unit confirms that the end address is not written in the index area portion, the address writing unit may write the address thus stored in the memory as the end address into the index area portion.

In the recording apparatus described above, the recording unit may store flag data which indicates whether an end address for addressing the last image data of the motion picture is written or not into the index area portion.

In the recording apparatus described above, the index area portion may have an area where the end address of the motion picture is stored, and the recording unit may store the flag data into the area of the index area portion.

The recording apparatus described above, further comprises: an index confirming unit which checks, based on the flag data, whether the end address for addressing the last image data of the motion picture is written or not into the index area portion.

In the recording apparatus described above, upon turning on the recording unit after the recording unit is once turned off, the index confirming unit may check whether the end address is written or not into the index area portion.

In the recording apparatus described above, if the index confirming unit confirms that the end address is not written in the index area portion, the address writing unit may write the address thus stored in the memory as the end address into the index area portion.

According to the second aspect of the present invention, there is provided a method for recording a motion picture comprising: sequentially writing image data of the motion picture into an image storage area portion of a recording unit; writing an address for addressing a first image data of the motion picture into an index area portion of the recording unit as a start address of the motion picture; and storing in a memory, an address for addressing a last image data which has been stored into the image storage area portion of the recording unit.

In the method described above, storing in the memory may include, each time the image data has been written into the image storage area portion, rewriting an address of the newly stored image data over the address presently stored in the memory.

In the method described above, the address rewriting may include rewriting the address each time the image data of one frame has been stored in the image storage area portion.

The method described above may further comprise: storing in the memory, flag data which indicates whether an end address for addressing the last image data of the motion picture is written or not into the index area portion.

The method described above may further comprise: checking, based on the flag data, whether the end address for addressing the last image data of the motion picture is written or not into the index area portion.

In the method described above, the checking may include checking, upon turning on the recording unit after the recording unit is turned off once, whether the end address is written or not into the index area portion.

In the method described above, the checking may include writing into the index area portion, if it is confirmed that the end address is not written in the index area portion, the address thus stored in the memory as the end address.

The method described above may further comprises: storing into the index area portion, flag data which indicates whether an end address for addressing the last image data of the motion picture is written or not.

In the method described above, the flag data may be stored into an area of the index area portion where the end address of the motion picture is stored.

The method described above may further comprises: checking, based on the flag data, whether the end address for addressing the last image data of the motion picture is written or not into the index area portion.

In the method described above, the checking may include checking, upon turning on the recording unit after the recording unit is turned off once, whether the end address is written or not into the index area portion.

The method described above may further comprises: writing, if the end address in the index area portion is confirmed as not written, the address thus stored in the memory as the end address into the index area portion.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an example of a data format for a recording unit in a recording apparatus.

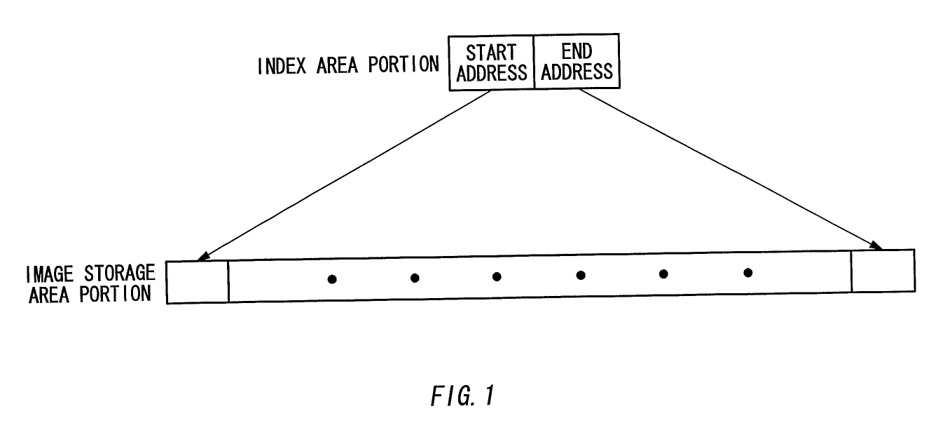

FIG. 2 shows a recording apparatus according to an embodiment of the present invention along with peripheral equipment with which the recording apparatus connects.

FIG. 3 shows brief internal constructions of the recording apparatus according to the embodiment of the invention.

FIG. 4 shows an example in which a memory stores a temporal end address and flag data.

FIG. 5 shows another example in which a memory stores a temporal end address while an index area portion stores flag data.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

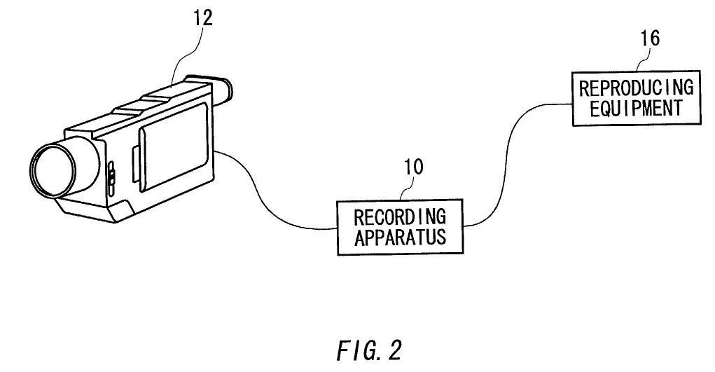

FIG. 2 shows a recording apparatus 10 according to an embodiment of the present invention along with peripheral equipment with which the recording apparatus 10 connects. In FIG. 2, the peripheral equipment includes a digital video camera 12 and reproducing equipment 16, each connecting with the recording apparatus 10. The recording apparatus 10 is capable of continuously recording a series of motion pictures. For example, digital image data captured by the digital video camera 12 or the like are transferred to the recording apparatus 10. When using an IEEE1394 digital interface, the digital image data without being subjected to compression for the time axis, like MPEG compression, may be transferred to the recording apparatus 10 at a high speed. Alternately, the image data may be transmitted with other interfaces having a high speed. The recording apparatus 10 stores the digital image data thus transmitted with the real time basis.

The recording apparatus 10 may include a recording apparatus body, and a hard disk unit that is detachably attached to the recording apparatus body that serves as a recording unit. Preferably, the recording apparatus body receives the digital image data transmitted with an IEEE1394 terminal, and feeds the data to the hard disk unit. The hard disk unit installs a hard disk body that stores the data received from the recording apparatus body. During transmission of the data, the digital image data continuing with the real time is written into the hard disk body.

According to another embodiment of the present invention, the recording apparatus 10 may be constituted such that a recording apparatus body and a hard disk unit serving as a recording unit are integrated as one unit. According to yet another embodiment, a hard disk unit which is attachable and detachable may be directly mounted on image capturing equipment such as a digital video camera 12.

At the reading out step, the data thus stored in the hard disk body is transmitted with the IEEE1394 to the reproducing equipment 16. The reproducing equipment 16 may be either a television or a computer with which a user may edit the image. In a case where the digital image data transmitted from the recording apparatus 10 is not subjected to the time compression process such as MPEG, a video edition can be easily achieved. For instance, while watching images displayed on the reproducing equipment, the user may pause and display his/her designating image thereon.

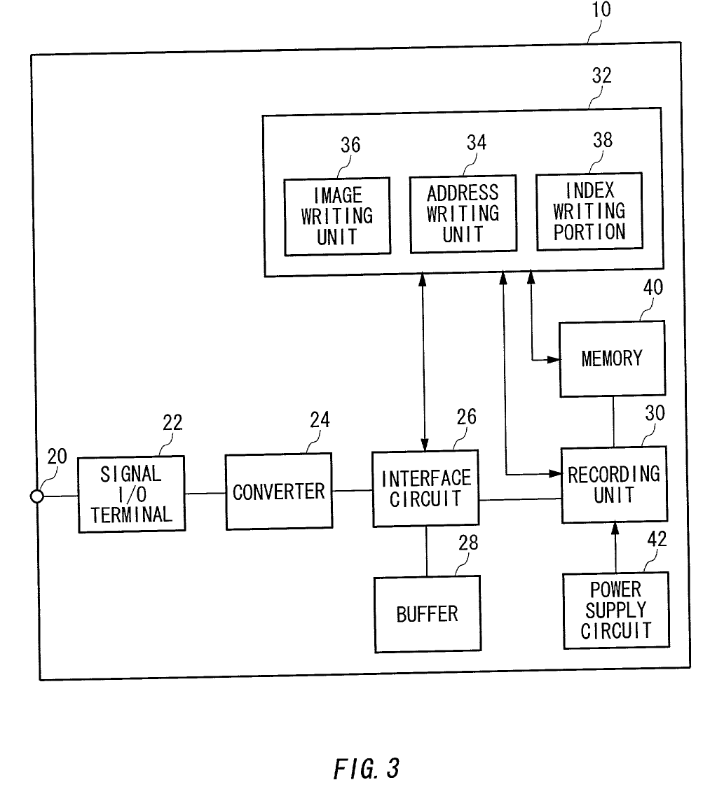

FIG. 3 shows brief internal constructions of the recording apparatus 10 according to the embodiment of the invention. The recording apparatus 10 includes an input/output terminal 20, a signal input/output unit 22, a converter 24, an interface circuit 26, a buffer 28, a recording unit 30, a control unit 32, a memory 40 and a power supply circuit 42. Preferably, the input/output terminal 20 may comprises an IEEE1394 terminal, which enables a high speed transmittal. The control unit 32, which has an address writing unit 34 and an image writing unit 36, is able to write the data into the recording unit 30 with a predetermined format. The control unit 32 further has an index confirming portion 38 and is able to check whether the end address indicating the storage position of the last image data of the captured motion picture is written into the recording unit 30 or not. Preferably, the recording unit 30 may be a recording medium allowing random access. For instance, the hard disk body may serve as the recording unit 30. More preferably, the recording unit 30 may have a large recording capacity for storing the image data of the motion picture without the compression process such as MPEG compression. The recording unit 30 is thus a kind of random access recording medium that has a large recording capacity, so that any of the image data recorded therein can be read out and the user can carry out the video edition with ease. The power supply circuit 42 supplies the electric power to the recording unit 30, and preferably also supplies the electric power to other elements and units involved with the recording apparatus 10.

The following will describe operations of elements and units of the recording apparatus 10 used to write the externally transmitted data into the recording unit 30. The externally transmitted data is input through the input/output terminal 20 into the signal input/output unit 22. The converter 24 converts the data to a processible format. The interface circuit 26 supplies the converted data to the buffer 28. When the prescribed data is accumulated in the buffer 28, the image writing unit 36 retrieves the data from the interface circuit 26 and controls the interface circuit 26 to write the data into the recording unit 30. For instance, in a case where the data under consideration is digital image data which is not subjected to compression in the direction of time, upon accumulating the data of one frame, the interface circuit 26 may be controlled to write the data of the one frame into the recording unit 30.

The recording unit 30 includes an image storage area portion which stores image data and an index area portion which stores addresses of the prescribed image data. In this embodiment, the image writing unit 36 allocates the image data of the motion picture to addresses in the recording unit 30, and controls to write this image data into the image storage area portion. Moreover, the address writing unit 34 controls to write the address identifying a storage position of the prescribed image data into the index area portion of the recording unit 30. More specifically, when the user presses a recording start button, the address writing unit 34 controls a start address which designates a storage position of the first image data of the motion picture to be written into the index area portion. When the user presses a recording stop button, the address writing unit 34 controls an end address which designates a storage position of the last image data of the motion picture to be written into the index area portion.

When an instruction to start recording the motion picture is received by the recording apparatus 10, the image writing unit 36 controls the first image data into the image storage area portion to be written at a first prescribed address in the image storage area portion of the recording unit 30, and the address writing unit 34 controls the first prescribed address to be written as a start address into the index area portion. As described above, the instruction to start recording the motion picture is issued upon the user's pressing the start button in this embodiment. However, it is not limited, and any other instructions to begin the recording may be available. The start address has already established before starting the recording, and therefore the start address may be written in the index area portion prior to staring the recording.

Successively, the image writing unit 36 allocates succeeding image data to sequence addresses in the recording unit 30, and controls the image data to be written into the image storage area portion in sequence.

When an instruction to stop recording the motion picture is received by the recording apparatus 10, the image writing unit 36 controls the last image data to be stored at an address in the image storage are a portion of the recording unit 30, and the address writing unit 34 controls this address to be written as an end address into the index area portion. As described above, the instruction to stop recording the motion picture is issued upon the user's pressing the stop button in this embodiment. However, it is not limited, and any other instructions to begin the recording may be available. For instance, the case where the recording is carried on only while the user is pressing a recording button, the instruction to stop the recording may be issued upon the user's releasing the recording button from pressing.

Subsequently, when the data recorded in the recording unit 30 is read out, the interface circuit 26 retrieves the prescribed data from the recording unit 30 to the buffer 28, and feeds this data to the converter 24. The converter 24 converts the data thus received into data according to the transmittal format, and outputs the converted data through the signal input/output unit 22 with the input/output terminal 20. The reproducing equipment 16 receives the start address and the end address, both stored in the index area portion. Then the reproducing equipment 16 reproduces, based on the start address and the end address, the image data of the motion picture stored in the image storage area portion.

Under the circumstance that the end address is properly written in the index area portion as described above, the reproducing equipment 16 recognizes the last image of the motion picture based on the end address, and therefore suitably reproduces the motion picture. On the contrary, if abnormal events occur, it may happen that no end address is written in the index area portion. The abnormal events include any event that the proper instruction to stop the recording is not issued because of running out the electric power of the power source during recording, accidentally shutting down the electric power to the recording unit 30, forcibly terminating the recording by errors on the video camera 12 or the recording apparatus 10, or the like. The recording apparatus 10 according to the embodiment of the present invention has a function capable to write the end address in the recording unit 30 so that the reproducing equipment properly reproduces the image data of the motion picture even if abnormal events occur on the recording apparatus 10 during recording.

According to the embodiment of the present invention, the memory 40 stores an address of the last image data which has been stored in the image storage area portion of the recording unit 30. The memory 40 may comprise a nonvolatile memory, which keeps on storing contents after the electric power is turned off. The address thus stored in the memory is used to serve as a temporal end address for the image data of the motion picture being recorded. Each time the image writing unit writes the image data into the image storage area portion, the address writing unit 34 controls to rewrite an address of the newly stored image data over the address presently stored in the memory 40. Therefore, the address which indicates the storage position of the latest image data having just been stored in the image storage portion is written in the memory 40.

The recording apparatus 10 is provided with flag data which indicates whether the end address for addressing the last image data of the designated motion picture is stored or not in the index area portion. For example, the memory 40 may store this flag data, which may comprise one bit data. When the end address is not written in the index are a portion, the flag data maintains a value indicating that the end address is not written. Upon detecting the user pressing the recording stop button in the control unit 32, the address writing unit 34 rewrites the flag data in the memory 40 to indicate that the end address has been written.

Alternately, the recording unit 30 may store the flag data. In this case, the recording unit 30 may store the flag data in an area of the index portion where the end address will be written. The recording unit 30 previously stores data having a value which is invalid for an end address such as all zeros. More specifically, upon turning on the power to the recording apparatus 10, the address writing unit 34 may write data of all zeros into the area of the index area portion where the end address will be written. Upon detecting the user pressing the recording stop button in the control unit 32, the address writing unit 34 replaces the value stored as the flag data with the end address indicating the storage position of the last image data of the motion picture.

Based on the flag data thus stored in either the memory 40 or the recording unit 30, the index confirming portion 38 checks whether the end address indicating the storage position of the last image data of the motion picture is written in the index area portion. In a case where the memory 40 stores the flag data having one bit, the index confirming portion 38 detects this flag data, and decides whether the end address is written, based on the logical value of the detected flag data. Alternately, in a case where the recording unit 30 stores the flag data in the area for storing the end address, the index confirming portion 38 detects this flag data, and decides whether the end address is written, based on the value of the detected flag data, for instance checking whether the value is all zeros or not.

When the electric power starts being supplied to the recording unit from a condition where no electric power has been supplied, it is preferable that the index confirming portion 38 checks whether the end address can be found in the index are a portion. For instance, when the user turns on the power source of the recording apparatus 10, the index confirming portion 38 detects the flag data and checks whether the end address is written or not. If the index confirming portion 38 has confirmed that the end address is not written in the index area portion, the address writing unit 34 writes the address presently stored in the memory 40 into the index are a portion as the end address. According to this embodiment of the invention, even if the recording has stopped improperly and therefore the end address has not been written in the index area portion, the end address is written in the index area portion upon turning on the power and it enables the reproducing equipment to properly reproduce the motion picture thus recorded.

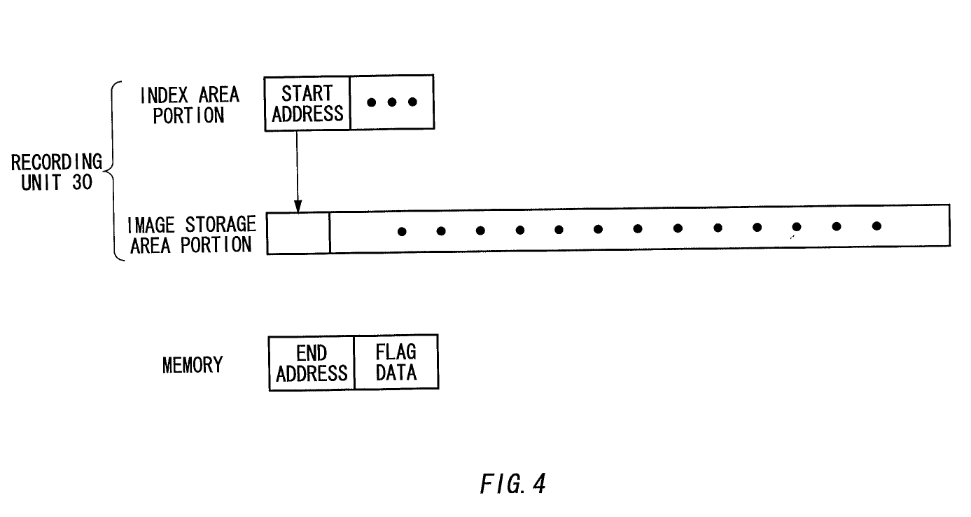

FIG. 4 shows an example in which a memory 40 stores a temporal end address and flag data. Each time the image data is written into the image storage area portion of the recording unit 30, the memory 40 stores an address of the newly stored image data as the temporal end data. In this case, the memory 40 may rewrite the address of the newly stored image data over the previous address already stored in the memory 40. The flag data may comprise one bit data which indicates whether the end address is written into the index area portion. For instance, until the end address is written in the index area portion, the flag data maintains its logical value of “0”. In this case, if it is confirmed that the end address is written in the index area portion, the flag data is changed to have its logical value of “1”. At the time when the power to the recording unit 30 is supplied by turning on after the power is turned off once, if the flag data has the value “0”, the address writing unit 34 writes the temporal end address stored in the memory 40 into the index area portion as the end address of the motion picture. Alternately, the flag data may maintain its logical value of “1” until it is written, while the flag data may be changed to have its logical value of “0”.

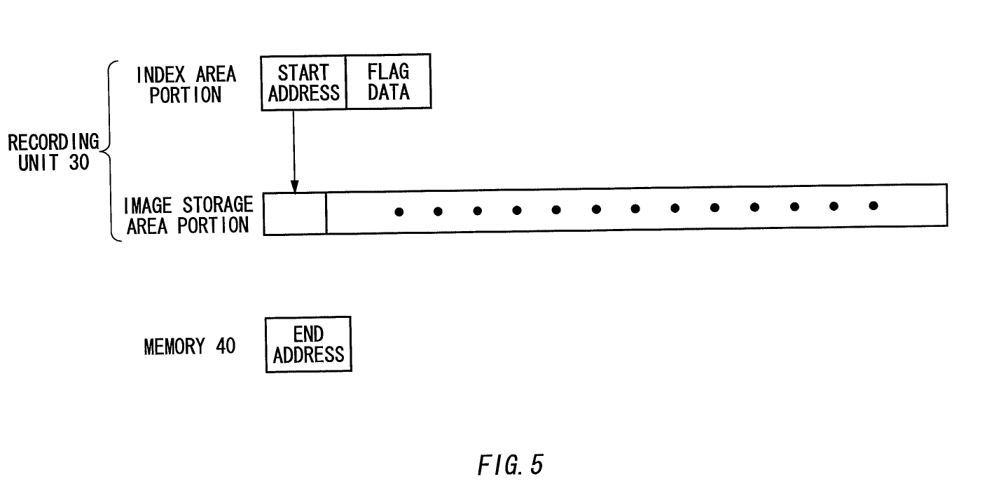

FIG. 5 shows another example in which the memory 40 stores a temporal end address while the index area portion stores flag data. Each time the image data is written into the image storage area portion of the recording unit 30, the memory 40 stores an address of the newly stored image data as the temporal end data. In this case, the memory 40 may rewrite the address of the newly stored image data over the previous address already stored in the memory 40. The flag data, which is a kind of data which indicates whether the end address is written in the index area portion or not, is stored into an area of the index area portion where the end address is to be stored. For instance, the flag data may have an invalid value for the end address such as all zeros before the end address is properly written into the index are a portion. Namely, all zeros are not assigned to the proper end address, so that the index confirming portion 38 can recognize whether the end address is properly written or not. After the power to the recording unit 20 is turned off once, at the time when the power to the recording unit 30 is supplied by turning on again, if the flag data has the value of all zeros, the address writing unit 34 writes the temporal end address stored in the memory 40 into the index area portion as the end address of the motion picture. As described above, the flag data may have a value consisting of all zeros. However, it is not limited to this. Other values which enable the index confirming portion 34 to check whether the end address is written or not may be available.

As is apparent from the description above, according to the invention, even if a recording is stopped without writing an end address in a recording unit of a recording apparatus, the end address is properly written in the recording unit afterwards. Therefore, a motion picture recorded in the recording apparatus, even under abnormal recording terminations, may be reproduced.

Although the present invention has been described by way of exemplary embodiments, it should be understood that those skilled in the art might make many changes and substitutions without departing from the spirit and the scope of the present invention which is defined only by the appended claims.

What is claimed is:

1. A recording apparatus for storing a motion picture having image data, said recording apparatus comprising:
a recording unit including an image storage area portion and an index area portion;
an image writing unit which sequentially writes the image data of the motion picture into the image storage area portion of the recording unit;
an address writing unit which writes an address for addressing a first image data of the motion picture into the index area portion of the recording unit as a start address of the motion picture; and
a memory in which an address for addressing a last image data which has been stored into the image storage area portion of the recording unit is stored.

2. The recording apparatus according to claim 1, wherein, each time the image writing unit has written the image data into the image storage area portion, the address writing unit rewrites an address of the newly stored image data over the address presently stored in the memory.

3. The recording apparatus according to claim 1, wherein the address writing unit rewrites the address each time the image data of one frame has been stored in the image storage area portion.

4. The recording apparatus according to claim 1, wherein flag data which indicates whether an end address for addressing the last image data of the motion picture is written or not into the index area portion is stored in the memory.

5. The recording apparatus according to claim 4, further comprising:
an index confirming unit which checks, based on the flag data, whether the end address for addressing the last image data of the motion picture is written or not into the index area portion.

6. The recording apparatus according to claim 5, wherein, upon turning on the recording unit after the recording unit is turned off once, the index confirming unit checks whether the end address is written or not into the index area portion.

7. The recording apparatus according to claim 5, wherein, if the index confirming unit confirms that the end address is not written in the index area portion, the address writing unit writes the address thus stored in the memory as the end address into the index area portion.

9. The recording apparatus according to claim 1, wherein the recording unit stores flag data which indicates whether an end address for addressing the last image data of the motion picture is written or not into the index area portion.

10. The recording apparatus according to claim 8, wherein the index area portion has an area where the end address of the motion picture is stored, and the recording unit stores the flag data into the area of the index area portion.

10. The recording apparatus according to claim 8, further comprising:
an index confirming unit which checks, based on the flag data, whether the end address for addressing the last image data of the motion picture is written or not into the index area portion.

11. The recording apparatus according to claim 10, wherein, upon turning on the recording unit after the recording unit is once turned off, index confirming unit checks whether the end address is written or not into the index area portion.

12. The recording apparatus according to claim 10, wherein, if the index confirming unit confirms that the end address is not written in the index area portion, the address writing unit writes the address thus stored in the memory as the end address into the index area portion.

13. A method for recording a motion picture comprising:
sequentially writing image data of the motion picture into an image storage area portion of a recording unit;
writing an address for addressing a first image data of the motion picture into an index area portion of the recording unit as a start address of the motion picture; and
storing in a memory, an address for addressing a last image data which has been stored into the image storage area portion of the recording unit.

14. The method according to claim 13, wherein storing in the memory includes, each time the image data has been written into the image storage area portion, rewriting an address of the newly stored image data over the address presently stored in the memory.

15. The method according to claim 14, wherein the address rewriting includes rewriting the address each time the image data of one frame has been stored in the image storage area portion.

16. The method according to claim 13, further comprising:
storing in the memory, flag data which indicates whether an end address for addressing the last image data of the motion picture is written or not into the index area portion.

17. The method according to claim 16, further comprising:
checking, based on the flag data, whether the end address for addressing the last image data of the motion picture is written or not into the index area portion.

18. The method according to claim 17, wherein the checking includes checking, upon turning on the recording unit after the recording unit is turned off once, whether the end address is written or not into the index area portion.

19. The method according to claim 18, where in the checking includes writing into the index area portion, if it is confirmed that the end address is not written in the index area portion, the address thus stored in the memory as the end address.

20. The method according to claim 13, further comprising:
storing into the index area portion, flag data which indicates whether an end address for addressing the last image data of the motion picture is written or not.

21. The method according to claim 20, wherein the flag data is stored into an area of the index area portion where the end address of the motion picture is stored.

22. The method according to claim 20, further comprising:
checking, based on the flag data, whether the end address for addressing the last image data of the motion picture is written or not into the index area portion.

23. The method according to claim 22, wherein the checking includes checking, upon turning on the recording unit after the recording unit is turned off once, whether the end address is written or not into the index area portion.

24. The method according to claim 22, further comprising:
writing, if the end address in the index area portion is confirmed as not written, the address thus stored in the memory as the end address into the index area portion.
